(19) United States
(12) Patent Application Publication
(10) Pub. No.: US 2004/0123271 A1
(43) Pub. Date: Jun. 24, 2004

(54) Remote debugging through firewalls

(76) Inventors: Jutta Bindewald, Angelbachtal (DE); Karsten Schmidt, Angelbachtal (DE); Axel Schmidt, Walldorf (DE); Achim Braemer, Heidelberg (DE); Hans-Christoph Rohland, St. Leon-Rot (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/672,288

(22) Filed: Sep. 26, 2003

(30) Foreign Application Priority Data
Sep. 26, 2002 (EP) 02021946.5

(51) Int. Cl. G06F 9/44; H04L 9/00

(52) U.S. Cl. 717/124; 713/152

(57) ABSTRACT

The present invention provides methods and apparatus, including computer program products, for debugging a computer program running on a system that is separated from the debugging system by at least one firewall. The computer program being debugged can be a Java application. A router on each side of the firewall can be used to establish communication between the two systems. To the debugging system, it appears that the computer program is running locally.

### CROSS-REFERENCE TO RELATED APPLICATIONS

This application claims the benefit of priority to European application serial no. 02021946.5, filed Sep. 26, 2002.

### BACKGROUND

The present invention relates to digital data processing, and more particularly to remote debugging of computer programs.

Debugging of computer programs can be performed by a debugging system that connects with the actual running application program. The debugging system can for example be off site, i.e., physically remote from the system running the application program. The communication between the application system and the debugger typically goes over computer networks and other communication links. This poses significant security risks.

In a typical remote debugging case, the debugger is located on a support site while the program is located on a customer site that is physically remote from the support site. Often a firewall protects each of the sites. A firewall is a set of related programs, typically located at a network gateway server, that protects the resources of a private network from users of other networks.

Conventional techniques exist for remote debugging. However, some conventional techniques do not work when the debugger and the program being debugged are separated by a firewall.

### SUMMARY OF THE INVENTION

The present invention provides methods and apparatus, including computer program products, for remote debugging through firewalls.

In general, in one aspect, a method in accordance with the invention includes running a debugging system on a local site, the local site being separated from a remote site by at least one firewall; storing data on the local site, the data including a local copy of a remote application that is running on a virtual machine located on the remote site; and making it appear to the debugging system that the remote application is running on the local site instead of the remote site by: establishing a communication link between a first router located on the local site and a second router located on the remote site; using the communication link between the first and second routers to establish communication between the debugging system and the virtual machine; receiving a timestamp indicating when the remote application was last modified; using the received timestamp to determine whether the local copy is up to date with respect to the remote application; and if the local copy is up to date, loading the local copy into the debugging system; and otherwise (i) comparing the local copy with the remote application to establish delta information that identifies differences between the local copy and remote application, (ii) retrieving the delta information from the remote site, (iii) using the retrieved delta information to alter the local copy to match the remote application, and (iv) loading the altered local copy into the debugging system.

The invention can be implemented to include one or more of the following advantageous features. The remote application is a component of a larger application that is running on the virtual machine. The virtual machine is a Java virtual machine. The at least one firewall comprises a first firewall protecting the local site and a second firewall protecting the remote site. The method further comprises sending commands from the debugging system to the virtual machine using the communication link. The method further comprises receiving run-time data and state information about the remote application from the virtual machine through the communication link. The router is an SAProuter.

The invention can be implemented to realize one or more of the following advantages. A system built in accordance with the invention reduces security risks and reduces the amount of data that needs to be transferred between the debugger and the program being debugged.

The details of one or more embodiments of the invention are set forth in the accompanying drawings and the description below. Other features and advantages of the invention will be apparent from the description, drawings, and claims.

### BRIEF DESCRIPTION OF DRAWINGS

FIG. 1 is a block diagram of a system with remote debugging in accordance with the invention.

FIG. 2 is a block diagram of one implementation of remote debugging.

FIG. 3 is a flow diagram of data flow within the system.

Like reference symbols in the various drawings indicate like elements.

### DETAILED DESCRIPTION

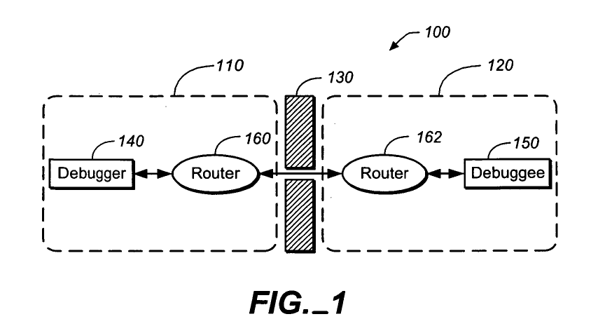

As shown in FIG. 1, an example local site 110 and remote site 120 communicate over a communications network, e.g., a WAN (wide area network) or a LAN (local area network). At least one firewall 130 separates the local site 110 from the remote site 120. In one implementation, the at least one firewall 130 is two firewalls, one protecting each of the two sites.

The local site 110 includes a debugger application 140 that is operable to debug a debuggee application 150 running on the remote site 120. Communication between the debugger and the remote site can occur over a communication link established by two routers 160, 162, one located on each side of the at least one firewall 130. The routers 160, 162 enable an indirect connection to be established between two programs when a direct connection between the two programs is restricted. In one implementation, each router 160, 162 is an SAProuter, available from SAP AG of Walldorf, Germany. The SAProuter only allows network access through fixed points or “holes” in the firewall. The SAProuter monitors each “hole” and uses a route permission table to identify the routes that can be used and the passwords required for access. In some implementations, the remote application is made to run in a debugging mode that is different from the normal run mode.

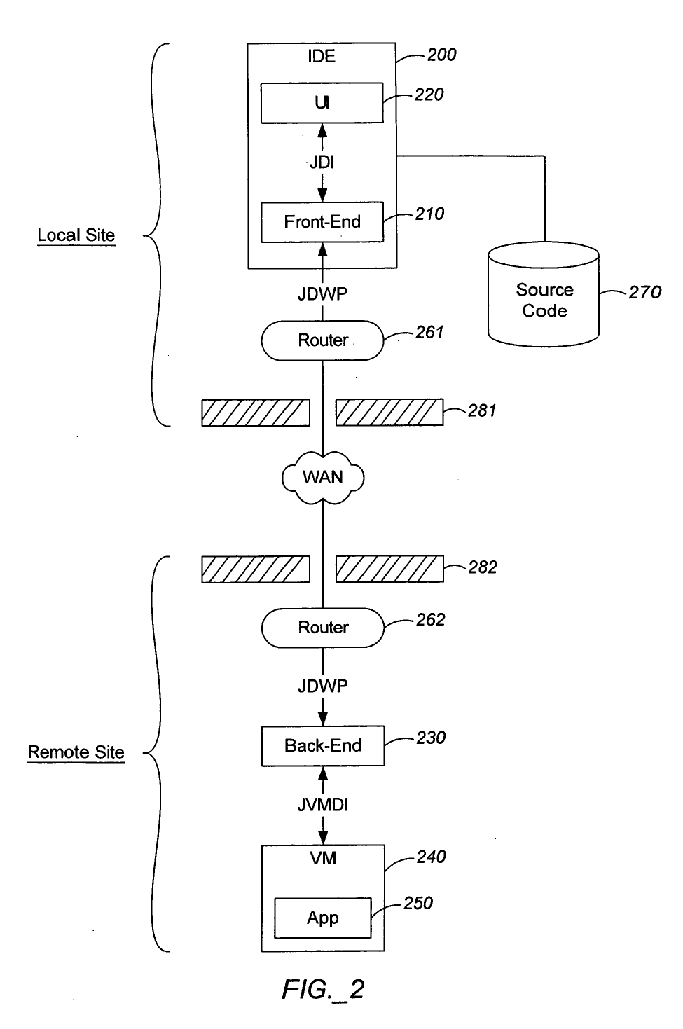

FIG. 2 shows an illustrative Java implementation that enables remote debugging through firewalls using the Java Platform Debugger Architecture (JPDA). Computer applications written in the Java language can be debugged using the JPDA, which is a multi-tiered debugging architecture that allows debugger applications to run portably across platforms, virtual machine (VM) implementations, and Software Development Kit (SDK) versions. The JPDA includes three layered APIs (Application Program Interfaces), which are: Java VM Debug Interface (JVMDI), which defines the debugging services a VM provides; Java Debug Wire Protocol (JDWP), which defines the communication between debuggee and debugger processes; and Java Debug Interface (JDI), which defines a high-level Java language interface for remote debugger applications.

The debuggee is the process being debugged; it includes the application 250 being debugged, with the target VM 240 running the application 250, and the back-end 230 of the debugger. Note that with respect to the JVMDI it is necessary that the target VM run in debug mode, i.e., in the mode that provides the debugging services, and implement the JVMDI.

The back-end 230 of the debugger communicates requests from the debugger front-end 210 to the target VM 250 and communicates the response to these requests (including desired events) to the front-end 210. The back-end 230 communicates with the front-end 210 over a communications channel using the JDWP. The back-end 230 communicates with the target VM 250 using the JVMDI. Typically, the back-end 230 is native code and the JVMDI is a pure native interface to prevent the debuggee and debugger support code from contending in ways that cause hangs and other undesired behavior.

The debugger front-end 210 implements the high-level JDI. The front-end 210 uses the information from the low-level JDWP to process the communication stream between the debugger and the debuggee. The user interface (UI) 220 to the debugger can be any type of user interface, for example, a graphical user interface (GUI), and can, for example, be implemented as clients of the JDI.

The JDWP specifies the format and semantics of the serialized bit-stream flowing over the communication channel between a debuggee and a debugger with respect to the debugging information and requests. Note that the channel runs between the front-end 210 (in the debugger process) and the back-end 230 (in the debuggee process), and that the bit-stream is transferred using a mechanism that allows network access through the firewall or firewalls protecting the local and remote systems. One such mechanism is a router, as described earlier.

In the reference implementation of JPDA, the reference implementation of the back-end provides the debuggee side of this channel, and the reference implementation of the front-end provides the debugger side. The front-end is a Java programming language component of the Java 2 Standard Edition Software Development Kit (J2SE SDK), located in the tools jar program collection provided with the SDK. The implementation of the transport mechanism according to the JDWP can be made using any suitable method; possible mechanisms include sockets, serial lines, and shared memory.

The debugging system of the example shown in FIG. 2 is implemented on a computer system that runs a dedicated Java IDE (integrated development environment) 200, for example, the JBuilder® IDE available from Borland Software Corporation of Scotts Valley, Calif., or an IDE based on the Eclipse Platform, available from Eclipse.org.

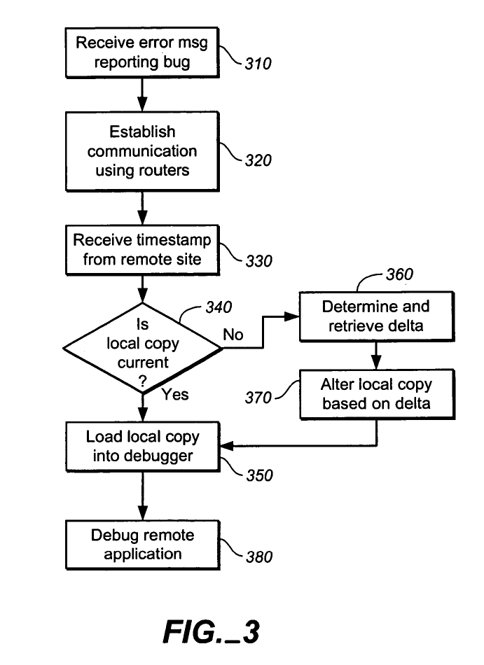

In use, as shown in FIG. 3, an error message regarding an application running on the remote site is reported to the local site, e.g., to a manually-run help desk located on the local site, or to any other error message collection point, for example, a computer-based customer service system (step 310). The error message is then transferred to an operator for resolution of the error. This can lead to the operator debugging the application, which will now be described.

The operator uses the facilities of a local site (debug system) on which a debugging application is running, for example, within the IDE (200, FIG. 2). In the example shown in FIG. 2, the debugging application is provided with a user interface 220 (for interaction with the operator) and the front-end 210 of the Java Debug Interface (JDI). The debug system makes contact with the target VM to be debugged by using the routers 261, 262 on the debug (local) side and the target (remote) side, respectively (step 320).

The local site router 261 communicates with the outside world through at least one firewall 281 protecting the local site. Establishing a communication link between the routers 261, 262 (and therefore through both firewalls 281, 282) is known in the art, and is for example used in the R/3 system of the integrated business solution mySAP.com made by SAP AG. Within the Java environment, it is required that the target VM 240 run in debug mode, so as to allow the debug application to attach to the VM.

The IDE 200 is provided with the source code as run by the target VM 240 to assist with the debugging. In one embodiment of the invention, a copy of the source code is stored in the IDE 200, is loaded into the IDE, or is provided by any other method from a source from inside a firewall 281 protecting the local site. The identification of the code to be debugged on the target VM 240 can be derived from an identification mark provided with or associated with the source code, for example, a timestamp provided by a software component delivery system. The identification mark can then be communicated from the remote system to the local system, for example, by verbal communication, or by e-mail or otherwise electronically. In one embodiment of the invention the debugger application retrieves the identification mark from the target VM 240 over the communication link between the routers 261, 262 (step 330). The identification mark provides the data on which the corresponding code is retrieved and loaded into the IDE 200. In particular, in the case that no modifications have been made to the code as supplied to the target VM 240, this has the advantage of reduced information exchange.

In one embodiment of the invention, the debugging system checks whether a copy of the code to be debugged is present on the local site based on the identification mark retrieved (decision step 340). If no corresponding code is found, a copy of the code is retrieved from the remote site. In one embodiment, the changes between code stored on the local site and code stored on the remote site are determined; only the delta information between the respective codes is transferred, thus reducing transfer cost, in particular when few changes in the code have been made on the remote site (step 360). The code present on the local site is altered using the delta information (step 370) to yield the code present on the target VM 240, which altered code is then loaded into the IDE 200 (step 350). The altered code can also be established on the local site, and a new identification mark established and stored with the code.

In one implementation, if there is more than one local copy of the identified source code, the debugger can use a time stamp to select the matching copy. The debugger compares the last modified date of the local copy with the date indicated by the timestamp. If the dates are the same, the debugger loads the local copy, e.g., from the repository 270, into the IDE 200 (step 350). If no modifications have been made to the source code after it was delivered to the remote site, this has the advantage of reduced information exchange.

Once a local copy of the code has been loaded into the IDE, the debugger proceeds to debug the remote application using the communication link to send commands to the remote application and to receive run-time data and state information about the application (380). To the debugger, it appears as if the remote application is running on the local site instead of the remote site.

Although in the described example of a virtual machine based embodiment, a Java environment is used, the invention is not limited to such an implementation. The invention can also be used with any other environment that supports virtual machines. Note that in a Java environment the Java VM must be run in debugging mode to allow a debugger to attach to the target VM; however, depending on the environment used, a special mode of the VM might not be required for a debugging process to attach to the VM.

Aspects of the invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by or incorporated in special purpose logic circuitry.

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method, comprising:
running a debugging system on a local site, the local site being separated from a remote site by at least one firewall;
storing data on the local site, the data including a local copy of a remote application that is running on a virtual machine located on the remote site; and
making it appear to the debugging system that the remote application is running on the local site instead of the remote site by:
establishing a communication link between a first router located on the local site and a second router located on the remote site;
using the communication link between the first and second routers to establish communication between the debugging system and the virtual machine;
receiving a timestamp indicating when the remote application was last modified;
using the received timestamp to determine whether the local copy is up to date with respect to the remote application; and
loading the local copy into the debugging system if the local copy is up to date, and otherwise (i) comparing the local copy with the remote application to establish delta information that identifies differences between the local copy and remote application, (ii) retrieving the delta information from the remote site, (iii) using the retrieved delta information to alter the local copy to match the remote application, and (iv) loading the altered local copy into the debugging system.

2. The method of claim 1, wherein the remote application is a component of a larger application that is running on the virtual machine.

3. The method of claim 1, wherein the virtual machine is a Java virtual machine.

4. The method of claim 1, wherein the at least one firewall comprises a first firewall protecting the local site and a second firewall protecting the remote site.

5. The method of claim 1, further comprising:
sending commands from the debugging system to the virtual machine using the communication link.

6. The method of claim 1, further comprising:
receiving run-time data and state information about the remote application from the virtual machine through the communication link.

7. A computer program product, tangibly embodied in an information carrier, the computer program product being operable to cause data processing apparatus to:
run a debugging system on a local site, the local site being separated from a remote site by at least one firewall;
store data on the local site, the data including a local copy of a remote application that is running on a virtual machine located on the remote site; and
make it appear to the debugging system that the remote application is running on the local site instead of the remote site by:
establishing a communication link between a first router located on the local site and a second router located on the remote site;
using the communication link between the first and second routers to establish communication between the debugging system and the virtual machine;
receiving a timestamp indicating when the remote application was last modified;
using the received timestamp to determine whether the local copy is up to date with respect to the remote application; and
loading the local copy into the debugging system if the local copy is up to date, and otherwise (i) comparing the local copy with the remote application to establish delta information that identifies differences between the local copy and remote application, (ii) retrieving the delta information from the remote site, (iii) using the retrieved delta information to alter the local copy to match the remote application, and (iv) loading the altered local copy into the debugging system.

8. The product of claim 7, wherein the remote application is a component of a larger application that is running on the virtual machine.

9. The product of claim 7, wherein the virtual machine is a Java virtual machine.

10. The product of claim 7, wherein the at least one firewall comprises a first firewall protecting the local site and a second firewall protecting the remote site.

11. The product of claim 7, wherein the router is an SAProuter.

12. The product of claim 7, further comprising instructions to:
send commands from the debugging system to the virtual machine using the communication link.

13. The product of claim 7, further comprising instructions to:
receive run-time data and state information about the remote application from the virtual machine through the communication link.

14. A data processing system, comprising:
means for running a debugging system on a local site, the local site being separated from a remote site by at least one firewall;
means for storing on the local site a local copy of a remote application that is running on a virtual machine located on the remote site; and
means for making it appear to the debugging system that the remote application is running on the local site instead of the remote site by:
establishing a communication link between a first router located on the local site and a second router located on the remote site;
using the communication link between the first and second routers to establish communication between the debugging system and the virtual machine;
receiving a timestamp indicating when the remote application was last modified;
using the received timestamp to determine whether the local copy is up to date with respect to the remote application; and
loading the local copy into the debugging system if the local copy is up to date, and otherwise (i) comparing the local copy with the remote application to establish delta information that identifies differences between the local copy and remote application, (ii) retrieving the delta information from the remote site, (iii) using the retrieved delta information to alter the local copy to match the remote application, and (iv) loading the altered local copy into the debugging system.

15. The system of claim 14, wherein the remote application is a component of a larger application that is running on the virtual machine.

16. The system of claim 14, wherein the virtual machine is a Java virtual machine.

17. The system of claim 14, wherein the at least one firewall comprises a first firewall protecting the local site and a second firewall protecting the remote site.

18. The system of claim 14, wherein the router is an SAProuter.

19. The system of claim 14, further comprising:
means for sending commands from the debugging system to the virtual machine using the communication link.

20. The system of claim 14, further comprising:
means for receiving run-time data and state information about the remote application from the virtual machine through the communication link.
